(19) United States
(12) Patent Application Publication
(10) Pub. No.: US 2015/0249795 A1
(43) Pub. Date: Sep. 3, 2015

(54) IMAGING PROCESSING APPARATUS AND METHOD

(71) Applicant: Samsung Electronics Co., Ltd., Suwon-si (KR)

(72) Inventors: Won-ho Cho, Suwon-si (KR); Dong-pan Lim, Yongin-si (KR); Tae-chan Kim, Yongin-si (KR)

(21) Appl. No.: 14/632,296

(22) Filed: Feb. 26, 2015

(30) Foreign Application Priority Data
Feb. 28, 2014 (KR) 10-2014-0023795

(51) Int. Cl. H04N 5/357; H04N 5/367; H04N 5/235; H04N 5/243; H04N 9/04; H04N 5/217

(52) U.S. Cl. CPC H04N 5/3572; H04N 9/045; H04N 5/217; H04N 5/2352; H04N 5/2353; H04N 5/243; H04N 5/367

(57) ABSTRACT

An image processor corrects for color shading and lens shading separately. The image processor may also provide dynamic range correction between color shading and lens shading correction. Whichever operation, color shading correction or lens shading correction employs lower correction values may be employed first in a sequence of operations that includes color shading, dynamic range, and lens shading corrections.

### CROSS-REFERENCE TO RELATED APPLICATION

This application claims the benefit of Korean Patent Application No. 10-2014-0023795, filed on Feb. 28, 2014, in the Korean Intellectual Property Office, the disclosure of which is incorporated herein in its entirety by reference.

### BACKGROUND

The inventive concept relates to an image processing apparatus and method, and more particularly, to an image processing apparatus for generating an image in which shading correction and wide dynamic range (WDR) correction is performed.

If the background of an object is too bright when an image is taken, the resulting image may be relatively dark. This phenomenon is called backlight and it may be corrected to improve image quality. Wide dynamic range correction technology may be employed for such correction. Wide dynamic range imaging may employ image sensors, such as photodiodes, having different exposure times (also referred to herein as different responsiveness or sensitivity), and combine images from the photodiodes with different sensitivities to compensate for different brightness levels in an image scene. Pixels disposed in a central part of an image sensor and pixels disposed in neighboring parts of the image sensor take different amounts of light due to optical characteristics of a lens included in a camera module (also referred to herein as a camera). Accordingly, lens shading, in which the brightness gradually decreases from the central part of an image to the neighboring parts, may occur and this, too, may be corrected to improve image quality.

### SUMMARY

Example embodiments of an image processing apparatus in accordance with principles of inventive concepts may include a color shading correction unit for correcting a color difference of image data; an image reconstruction unit for reconstructing color-corrected image data to increase the dynamic range of image data; and a lens shading correction unit for correcting lens shading of reconstructed color corrected image data.

Example embodiments of an image processing apparatus in accordance with principles of inventive concepts may include a color shading correction unit configured to receive image data an image sensor having pixels of different exposure times.

Example embodiments of an image processing apparatus in accordance with principles of inventive concepts may include a color shading correction unit configured to apply different correction gains to different color channels of the image data.

Example embodiments of an image processing apparatus in accordance with principles of inventive concepts may include an image reconstruction unit configured to combine a first pixel data and second pixel data of image data, wherein the first pixel data and the second pixel data are obtained from pixels having different exposure times.

Example embodiments of an image processing apparatus in accordance with principles of inventive concepts may include an image reconstruction unit configured to expand a bit depth of the pixel data of the image data.

Example embodiments of an image processing apparatus in accordance with principles of inventive concepts may include a bit depth conversion unit configured to reduce the expanded bit depth of the pixel data.

Example embodiments of an image processing apparatus in accordance with principles of inventive concepts may include a value of a correction gain applied in the color shading correction unit is smaller than a value of a correction gain applied in the lens shading correction unit.

Example embodiments of an image processing apparatus in accordance with principles of inventive concepts may include a pixel array comprising a plurality of pixel groups having different exposure times configured to convert received light into electrical signals and to output the electrical signals; and an analog-digital converter configured to for convert electrical signals output by the pixel array into digital signals.

Example embodiments of an image processing apparatus in accordance with principles of inventive concepts may include a pixel array comprising a first pixel group having a first exposure time and a second pixel group having a second exposure time, and wherein pixels of the first and second pixel groups are alternately arranged according to line units or pixel units.

Example embodiments of an image processing apparatus in accordance with principles of inventive concepts may include a noise removal unit for removing noise from raw data obtained by the pixel array; and a bad pixel processing unit for correcting data of defective pixels from among pixels of the image data of which the color difference is corrected.

Example embodiments of an image processing method in accordance with principles of inventive concepts may include obtaining image data; correcting a color difference of the image data; increasing a dynamic range of the color-corrected image data; and correcting lens shading of the color-corrected dynamic-ranged increased data.

Example embodiments of an image processing method in accordance with principles of inventive concepts may include obtaining image data comprising obtaining the image data from pixels of an image sensor which have different exposure times.

Example embodiments of an image processing method in accordance with principles of inventive concepts may include correcting color difference comprising applying a value of a correction gain, which is smaller than a value of a correction gain applied in correcting the lens shading, to the pixel data of the image data.

Example embodiments of an image processing method in accordance with principles of inventive concepts may include removing noise from the image data; and correcting data from defective pixels from among pixels of the image data.

Example embodiments of an image processing method in accordance with principles of inventive concepts may include converting a bit depth of the image data of which a dynamic range is increased.

Example embodiments of an image processing method in accordance with principles of inventive concepts may include determining color shading correction values for a pixel array; determining lens shading correction values for a pixel array; an applying whichever set of correction values is of a lesser magnitude to image data first, then applying the other set of correction coefficients to the resultant data.

Example embodiments of an image processing method in accordance with principles of inventive concepts may include determining whether dynamic range correction is to be employed and, if it is, performing dynamic range on the resultant of the first of the color shading or lens shading correction operations performed.

Example embodiments of an image processing method in accordance with principles of inventive concepts may include color shading correction, dynamic range correction and lens shading correction are performed sequentially.

Example embodiments of an image processing method in accordance with principles of inventive concepts may include compensating for defective pixel data.

Example embodiments of an image processing method in accordance with principles of inventive concepts may include correction values determined using a uniformly white test image.

Example embodiments of an image processing method in accordance with principles of inventive concepts may include correction values are derived from a correction function of an order at least of a quadratic order.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of an image processing apparatus in accordance with principles of inventive concepts;

FIGS. 2A through 2D show generation of image data in a pixel array by varying exposure times in each line or in each pixel;

FIG. 3 shows lens shading;

FIG. 4 shows lens shading correction;

FIGS. 5A and 5B show color shading correction in accordance with principles of inventive concepts;

FIGS. 6A and 6B show lens shading correction in accordance with principles of inventive concepts;

FIG. 7 is a schematic block diagram of an image processing apparatus according to another embodiment of the inventive concept;

FIG. 8 is a schematic block diagram of an image processing apparatus according to another embodiment of the inventive concept;

FIG. 9 is a flowchart of a method of processing an image, in accordance with principles of inventive concepts;

FIG. 10 is a flowchart of a method of processing an image, according to another embodiment of the inventive concept;

FIG. 11 is a diagram of a photographing apparatus in accordance with principles of inventive concepts;

FIG. 12 is a diagram of a photographing apparatus according to another embodiment of the inventive concept;

FIG. 13 is a diagram of a photographing apparatus according to another embodiment of the inventive concept;

FIG. 14 is a block diagram of a computing system including the photographing apparatuses of FIGS. 11 through 13; and

FIG. 15 is a block diagram of an electronic system in accordance with principles of inventive concepts.

### DETAILED DESCRIPTION OF THE EMBODIMENTS

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, these example embodiments are provided so that this description will be thorough and complete, and will convey the scope of inventive concepts to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items and the term “or” is meant to be inclusive, unless otherwise indicated.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of inventive concepts.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of inventive concepts.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

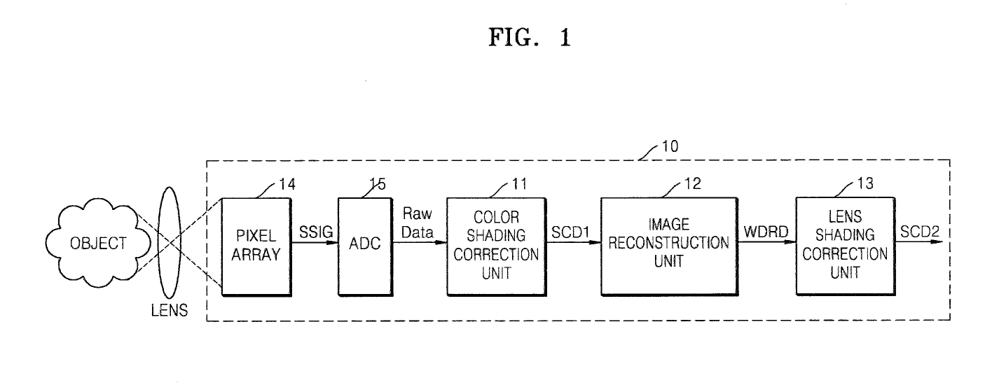

FIG. 1 is a block diagram of an example embodiment of an image processing apparatus 10 in accordance with principles of inventive concepts. The image processing apparatus 10 includes a color shading correction unit 11, an image reconstruction unit 12, and a lens shading correction unit 13. The image processing apparatus 10 may also include a pixel array 14 and an analog-digital converter (ADC) 15 and may be implemented as an image sensor.

The pixel array 14 includes pixels and converts optical image signals, which are reflected from an object and received through a lens, into electrical signals. The electrical signals are output as photographing signals SSIG. The pixels included in the pixel array 14 may be arranged in a matrix form, for example. The pixel array 14, for example, may be implemented as a charge-coupled device (CCD) or a complementary metal oxide semiconductor (CMOS) device. Alternately, the pixel array 14 may be two-dimensional arrangement of various photoelectric conversion devices such as photodiodes.

The pixel array 14 may include pixel groups having different exposure times. For example, the pixel array 14 may include a first pixel group having a first, short, exposure time (exposure_short) and a second pixel group having a second, long, exposure time (exposure_long). Pixels of the first and second pixel groups may be alternately arranged by line units or by pixel units. Pixel data may be generated by pixels of the pixel groups. Accordingly, the pixel data having different exposure times in each predetermined area may be generated as the image in one frame. That is, an image may be developed by each set of pixels in each image frame and, because the distribution of pixels of different exposure times throughout the imaging, or pixel, array 14 may differ, the image obtained by each set of pixels may differ and they are combined to form a complete image. In accordance with principles of inventive concepts, image correction may include a plurality of shading corrections, including color shading correction and lens shading correction, and wide dynamic range (WDR) correction. In example embodiments color shading correction is carried out before wide dynamic range correction, then, after wide dynamic range correction, lens shading correction is performed.

The ADC 15 converts analog image signals SSIG into digital signals and outputs the digital signals as raw data.

The color shading correction unit 11 corrects for color difference of the image data. Color difference is a distortion of colors in an image that, typically, increases with distance from the center of an image. The image data is brightness data, corresponding to light flux, received at a photoreceptor and one frame of an image includes image data from a plurality of photoreceptors, also referred to herein as pixels, within an imaging system, also referred to herein as a camera. In example embodiments, image data may be raw data provided by the ADC 15.

Pixel data of neighboring pixels, particularly neighboring color pixels related to the same image location, should be the same for the same light intensity. That is, data related to a red or green photoreceptor receiving the same illumination as a blue photoreceptor, should yield the same data value. The same applies for cyan, magenta, and yellow, systems. However, because, for example, color channel properties of color filters may be different, pixel data of pixels included in different color channels from among neighboring pixels (pixels associated with the same image location, for example) may be different and a color difference in image data may occur. The color shading correction unit 11 may correct the color difference of color channels of image data by applying correction gains having different values to each color channel. For example, a correction gain function having different coefficients may be preset for each color channel, and the color shading correction unit 11 may apply the correction gain function of each color channel to the respective data associated with pixels of each color channel in order to output corrected pixel data. In example embodiments, the correction gain function of each color channel may be a function of at least quadratic order. Various methods of correction are contemplated within the scope of inventive concepts and, for example, a lookup table for storing correction gain values of the color channels may be employed.

In example embodiments image reconstruction unit 12 performs wide dynamic range correction (also referred to herein as dynamic range correction) on the image data SCD1. As noted above, image data SCD1 has been color-corrected. As described above, when the pixel array 14 includes pixel groups having different exposure times and when the pixel data having different exposure times per predetermined area is generated as an image in one frame, the image reconstruction unit 12 combines the pixel data obtained by the pixels having different exposure times and may generate wide dynamic range-corrected image data WDRD (hereinafter, referred to as a WDR or wide dynamic range image data) of which a dynamic range is expanded. As a result, a bright part and a dark part of the wide dynamic range image data WDRD may be clarified.

In example embodiments image reconstruction unit 12 combines the pixel data of the pixels having different exposure times and may increase the bit-depth of the image data. For example, if the pixel data of the image data applied to the image reconstruction unit 12 is 10-bit data, the 10-bit data may be increased to 12-bit or 14-bit data by combinations of the pixel data. As a result, the dynamic range of the image data may be increased by about four times or about sixteen times, respectively.

According to another embodiment, the image reconstruction unit 12 receives image data of two frames having different exposure times and may generate a wide dynamic range image by combining the image data of the two frames, for example.

In example embodiments in accordance with principles of inventive concepts, when a wide dynamic range correction function of the image processing apparatus 10 is not required, for example, when the wide dynamic range correction is not required because a photographed image does not have a bright part and a dark part, image data of which color shading is corrected in the image processing apparatus 10 (SCD1) may bypass the image reconstruction unit 12 and may be provided to the lens shading correction unit 13.

The lens shading correction unit 13 performs lens shading correction on the wide dynamic range image data WDRD (or color-shading corrected data SCDI, when wide dynamic range correction is bypassed). In example embodiments, lens shading correction unit 13 corrects brightness differences that may occur according to locations of pixels in the pixel data of the image data and removes vignetting that results from lens shading.

In example embodiments lens shading correction unit 13 may calculate a preset correction gain function together with each pixel data of the image data and outputs the corrected pixel data. In example embodiments, the correction gain function may be at least of quadratic order. As described above, various correction methods may be applied. For example, a method of using a lookup table for storing correction gain values per location (that is, for each pixel location, for example) of the pixels may be employed.

The correction gain of the color shading correction unit 11 may be smaller than that of the lens shading correction unit 13. For example, coefficients of the correction gain function for the color shading correction may be smaller than those of the correction gain function for the lens shading correction.

Hereinafter, an example method of correcting an image in accordance with principles of inventive concepts using the image processing apparatus 10 of FIG. 1 and operations of each component will be explained in detail.

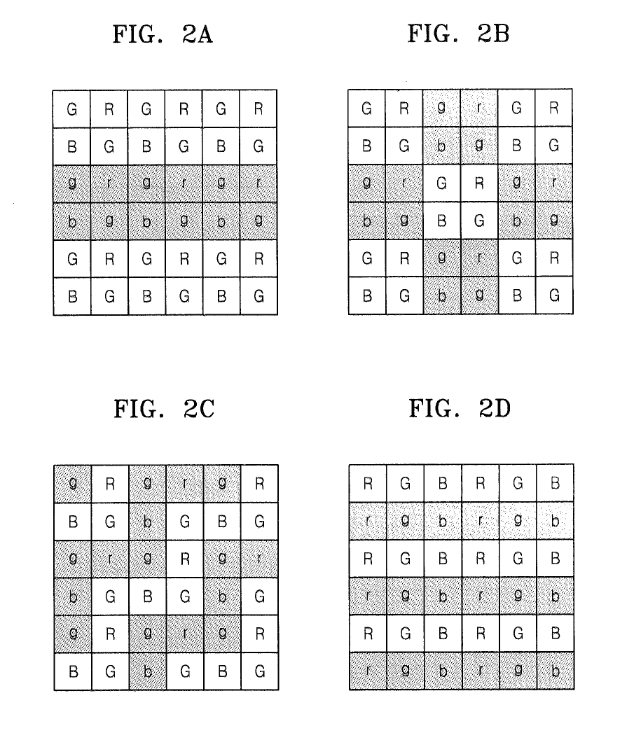

FIGS. 2A through 2D illustrate the generation of image data in the pixel array 14 by varying the exposure times, depending on each line or each pixel. FIGS. 2A through 2C illustrated an embodiment in which a color filter array applied to the pixel array 14 of FIG. 1 exhibits a bayer pattern, and FIG. 2D illustrate an embodiment in which a color filter array exhibits a red-green-blue (RGB) pattern unlike the bayer pattern.

The pixels shown in example embodiment of FIGS. 2A through 2D may be classified into a first pixel group having a long exposure time and a second pixel group having a short exposure time. Pixels indicated by capitals (R, G and B) are pixels of the first, long exposure, pixel group, and pixels indicated by lower cases (r, g and b) are pixels of the second, short exposure, pixel group.

In the example embodiment of FIG. 2A, the pixels R and r and the pixels G and g are alternately arranged in any one of the lines in the bayer pattern, and the pixels G and g and the pixels B and b are alternately arranged in a next line. As shown in FIG. 2A, exposure times may vary per two lines in the bayer pattern. Because one line does not include all of the pixels required for color reproduction (that is, R, G and B), color may not be easily predicted when the exposure times are different in every line. As a result, in example embodiments every two lines, including all of the pixels R, G and B, may be made to have the same exposure time.

In the example embodiment of FIG. 2B, the exposure times may vary according to pixel units. As described above, the exposure times may vary according to a two-by-two pixel unit including all of the pixels R, G, and B.

In the example embodiment of FIG. 2C, in the case of the pixels G and g, the pixels G in each line have the same type of exposure time. The pixels g having the short exposure time and the pixels G having the long exposure time are alternately arranged in each line. In the case of the pixels R, r, B, and b, the pixels R and r and the pixels B and b are arranged in a chess mosaic scheme form. In each channel, pixels adjacent to the pixels R, r, B, and b in a horizontal direction and in a vertical direction are pixels having an exposure time that is different from the exposure times the pixels R, r, B, and b, and pixels adjacent to the pixels R, r, B, and b in a diagonal direction are pixels having the same exposure time as the exposure times the pixels R, r, B, and b. When the pixels R, r, B and, b are arranged in a chess mosaic scheme form, the resolution of an image is improved and a ghost artifact thereof may be reduced.

In the example embodiment of FIG. 2D, because the pixels R, r, G, g, B, and b are arranged in one line unlike the arrangement in the bayer pattern, the exposure times thereof may vary. In the pixel array of FIG. 2D, the exposure times may vary according to line units or one-by-three pixel units each including the pixels R, r, G, g, B, and b. In this example embodiment, lines of long- and short-exposure pixels alternate on a line-by-line basis and each three-pixel unit in a line includes a red, green and blue pixel.

As described above, image data having different exposure times in each area, including pixel groups having different exposure times, may be generated using the pixel array 14 of FIG. 1. Image reconstruction unit 12 in accordance with principles of inventive concepts may generate a wide dynamic range image by combining the pixel data of the pixels having different exposure times. In embodiments in which the pixels G have the long exposure time, for example, the pixel data of the pixels G may be corrected by normalizing values of the neighboring pixels g having short exposure times and interpolating the normalized values and values of the pixels G. Inventive concepts are not limited thereto, however, and various image correction algorithms may be used in order to make the pixel data of the neighboring pixels smoothly connect and prevent the ghost artifact and definition degradation.

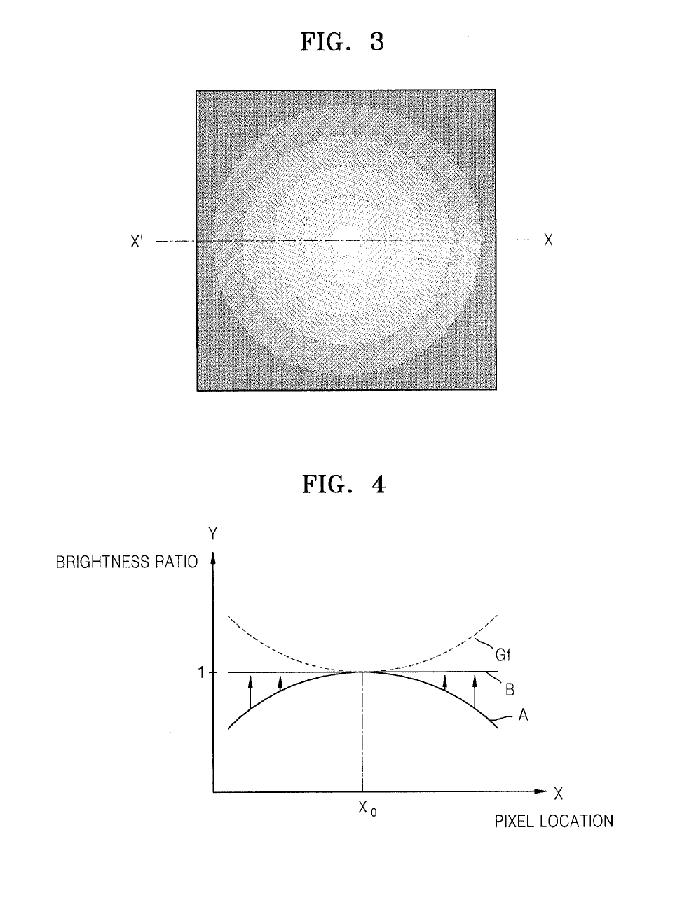

FIG. 3 illustrates lens shading, and FIG. 4 shows an example embodiment of lens shading correction in accordance with principles of inventive concepts. The demand for compact cameras leads to smaller lens diameters, which, in turn, lead to an increase in the chief ray angle (CRA). The result of an increased CRA may be a phenomenon in which the brightness of edges of an image is lower than that of a central area of the image, that is, the lens shading, as diagrammatically illustrated in FIG. 3. Lens shading may be intensified in a high-resolution sensor, and when the area where light is received is decreased in order to increase the depth of an image, lens shading may be more intensified.

In the graphical representation of FIG. 4, a distribution of brightness ratios of pixels, as in FIG. 3, is indicated along a line x-x′. Curved line A illustrates a brightness ratio distribution along line x-x′ before lens shading correction, and a solid line B illustrates a lens shading correction result. Curved dashed line Gf illustrates aa correction gain function in accordance with principles of inventive concepts that yields the corrected result of line B. The brightness ratio may be calculated as a ratio between pixel data of the pixels around a center X₀ and pixel data of the pixels in respective locations. In this example embodiment the brightness ratio decreases from the center X₀ to the edges of the image. In example embodiments in accordance with principles of inventive concepts the correction gain function Gf is calculated and correction values are calculated by applying the correction gain function to each pixel of the image data so as to remove the vignetting. The correction gain function Gf may be a function of at least a quadratic order, and, as described above, correction gains of respective location of the pixels according to the correction gain function Gf may increase with pixel distance from the center X₀ of the image.

Although color shading and the lens shading could be simultaneously corrected by calculating correction gain functions for color channels and applying the correction gain functions to the pixels in each color channel, a system and method in accordance with principles of inventive concepts breaks color correction and lens shading correction into separate functions and applies color correction, wide dynamic range correction (also referred to herein as reconstruction or enhancement) and lens shading correction in sequence. In example embodiments in accordance with principles of inventive concepts, the image processing apparatus 10 of FIG. 1 includes both the lens shading correction unit 13 and the color shading correction unit 11 and corrects color shading prior to wide dynamic range correction and then corrects lens shading. In accordance with principles of inventive concepts a correction function for color shading correction and a separate correction function for lens shading correction may be calculated, rather than simply calculating a color correction and lens correction function for each color channel.

If both color and lens shading were corrected before wide dynamic range correction, values of the pixel data would be increased according to high correction gains and, when data clamping is performed after shading correction, data may be lost due to the saturation of values. On the other hand, if color and lens shading correction were performed after WDR correction, the linearity of the pixel data may be broken and a color difference, for example, a difference between a channel Gr and a channel Gb, may occur.

Accordingly, in an apparatus and method in accordance with principles of inventive concepts, image processing apparatus 10 corrects color shading by applying a first correction function before applying wide dynamic range correction, after which, the lens shading correction unit 13 applies a second, lens shading correction function to the resultant WDRD image. In this manner, in accordance with principles of inventive concepts, shading of the image may be corrected without the data loss or color difference by separating color shading correction and lens shading correction and by performing wide dynamic range correction between color- and lens-shading correction.

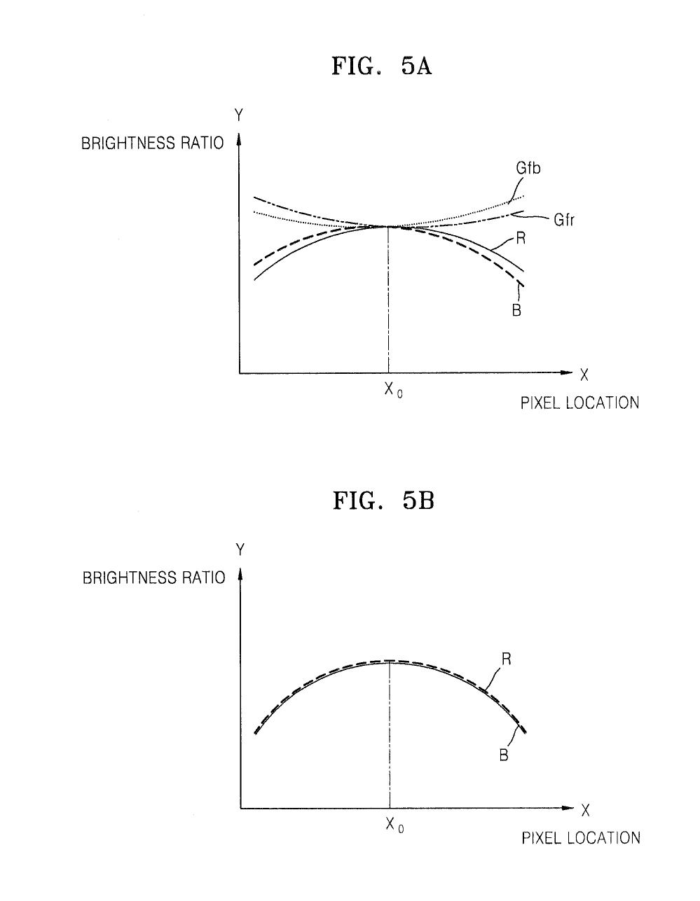

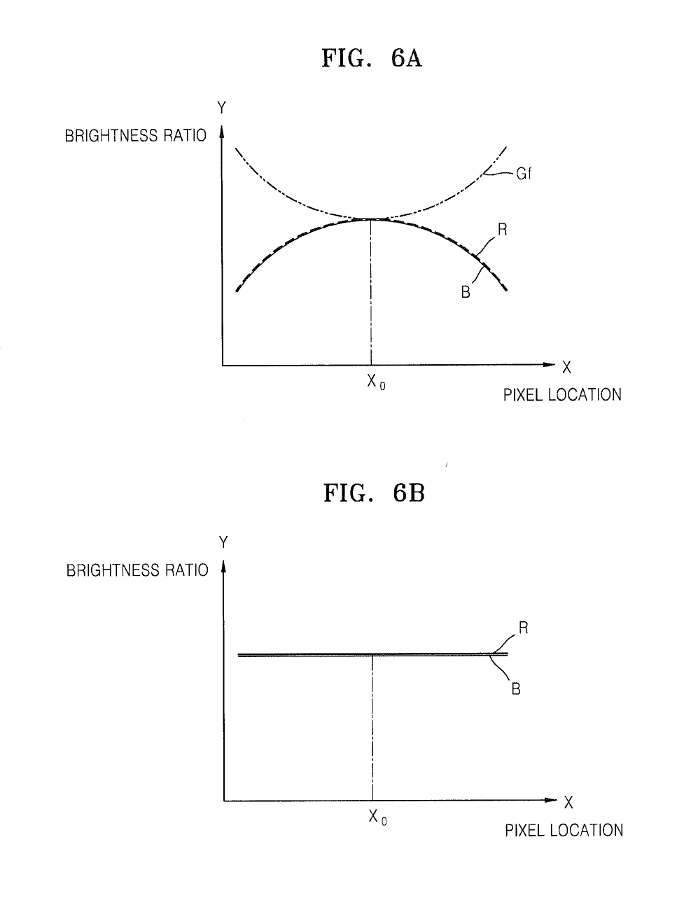

FIGS. 5A and 5B show color shading correction, and FIGS. 6A and 6B show lens shading correction in accordance with principles of inventive concepts. In this example embodiment, line R corresponds to a color channel R (which may be a red channel) and line B corresponds to a color channel B (which may be a blue channel).

Referring to FIG. 5A, the brightness ratio between locations of channel R (line R) channel B (line B) do not coincide with one other, indicating a color difference. In example embodiments in accordance with principles of inventive concepts, correction gain functions Gfr and Gfb may be calculated for each color channel and pixel data is amplified by applying respective correction gain functions Gfr and Gfb to pixels of each color channel to remove the color difference between channels R and B (that is, to perform color correction), as illustrated in in FIG. 5B. After color correction is performed, the brightness ratios of each pixel location is the same for each color channel (red, green and blue in this example embodiment), the brightness ratio of each location of each pixel may be the same (given a test or calibration image, such as a white image, for example).

Referring to FIG. 6A, pixel data is amplified by applying the same, lens-shading correction gain function Gf to pixels of channel R (line R) and channel B (line B). As a result, as illustrated in FIG. 6B, the brightness ratio of each pixel (red and green (and blue)) at each may be the same. Because, in this example embodiment the brightness ratios of the channel R (the line R) and the channel B (the line B) are the same (as a result, for example, of color correction), the same lens-shading correction gain function Gf may be applied to pixels of both (or all three) color channels.

In this example embodiment, coefficients of the correction gain functions Gfr and Gfb for each channel may be smaller than those of the correction gain function Gf of FIG. 6A. In example embodiments in accordance with principles of inventive concepts, because correction gains for color shading may be smaller than correction gains for lens shading color shading correction may be applied before wide dynamic range correction without saturating pixels. In example embodiments in accordance with principles of inventive concepts, wide dynamic range correction is performed between color and lens-shading corrections.

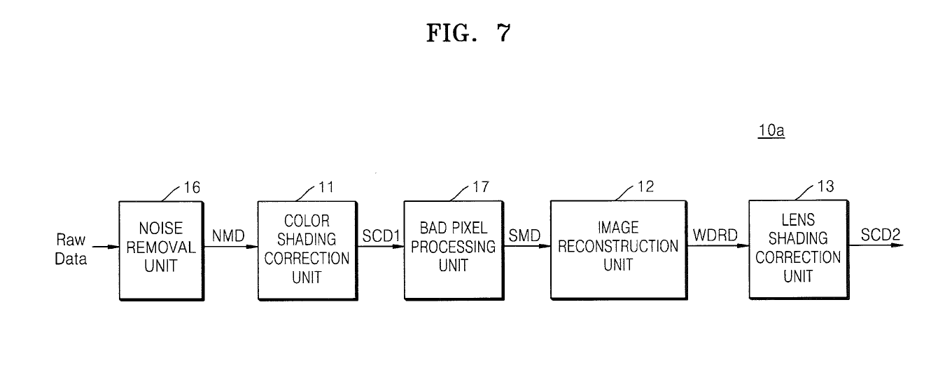

FIG. 7 is a schematic block diagram of an example embodiment of an image processing apparatus 10a in accordance with principles of inventive concepts. Image processing apparatus 10a may include a noise removal unit 16, a color shading correction unit 11, a bad pixel processing unit 17, an image reconstruction unit 12, and a lens shading correction unit 13. The image processing apparatus 10a may also include pixel array 14 and analog-to-digital converter ADC 15 as in FIG. 1. The noise removal unit 16 may remove or reduces noise, such as fixed-pattern noise and bad pixel processing unit 17 may correct data related to defective pixels in pixel array 14. In example embodiments, bad pixel processing unit 17 may replace pixel data corresponding to bad pixels in image data with another piece of pixel data. For example, interpolation values corresponding to values of the pixel data of pixels that are in the same color channel with the bad pixels and are adjacent to the bad pixels may replace the pixel data.

In FIG. 7, the noise removal unit 16 is arranged in front of the color shading correction unit 11, and the bad pixel processing unit 17 is arranged behind the color shading correction unit 11. However, arrangement of the components is not limited thereto. The image processing apparatus 10a may also include logic circuits to improve the definition of an image.

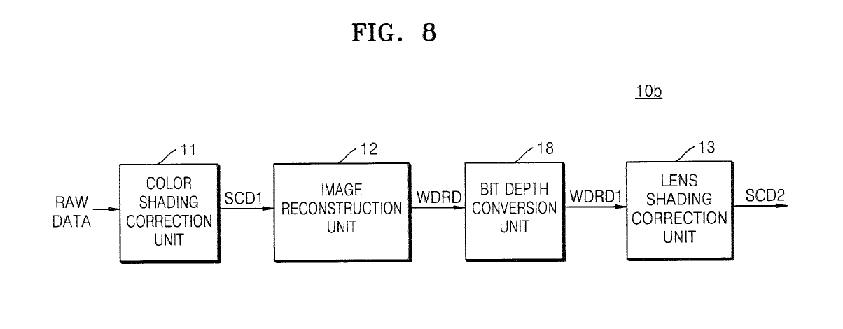

FIG. 8 is a schematic block diagram of an example embodiment of an image processing apparatus 10b in accordance with principles of inventive concepts. Image processing apparatus 10b includes a color shading correction unit 11, an image reconstruction unit 12, a bit depth conversion unit 18, and a lens shading correction unit 13. In comparison with the image processing apparatus 10 of FIG. 1, the image processing apparatus 10b further includes the bit depth conversion unit 18 arranged between the image reconstruction unit 12 and the lens shading correction unit 13. In example embodiments in accordance with principles of inventive concepts, bit depth conversion unit 18 may be employed to decrease the bit depth of image data WDRD in order to accommodate memory capacity limitations, for example. That is, although image reconstruction unit 12 expands the bit depth of pixel data and thereby expands dynamic range, other limitations, such as memory capacity limitations, may prompt bit depth reduction, which a system in accordance with principles of inventive concepts may implement without decreasing the dynamic range achieved by image reconstruction unit 12. Such bit depth conversion may be achieved without decreasing the dynamic range of image data WDRD by nonlinearly converting bits of the pixel data in an area having greater data values, rather than linearly converting high valued pixel data (for example, fourteen-bit) into lower valued pixel data (for example, into ten-bit).

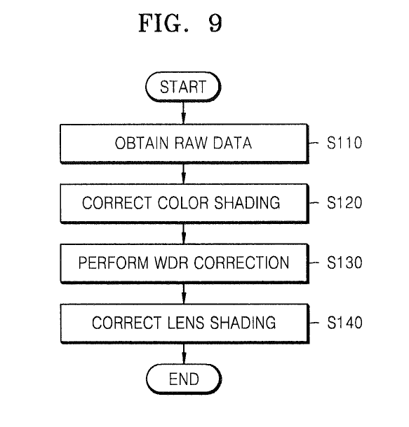

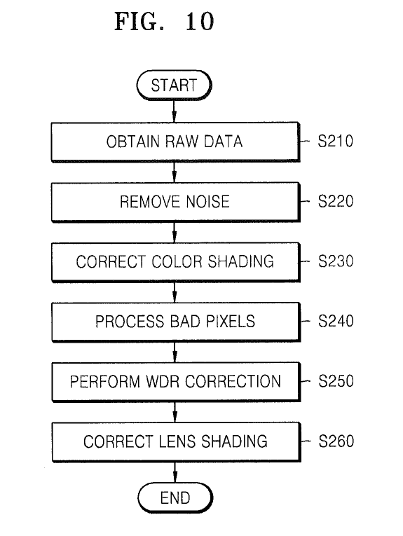

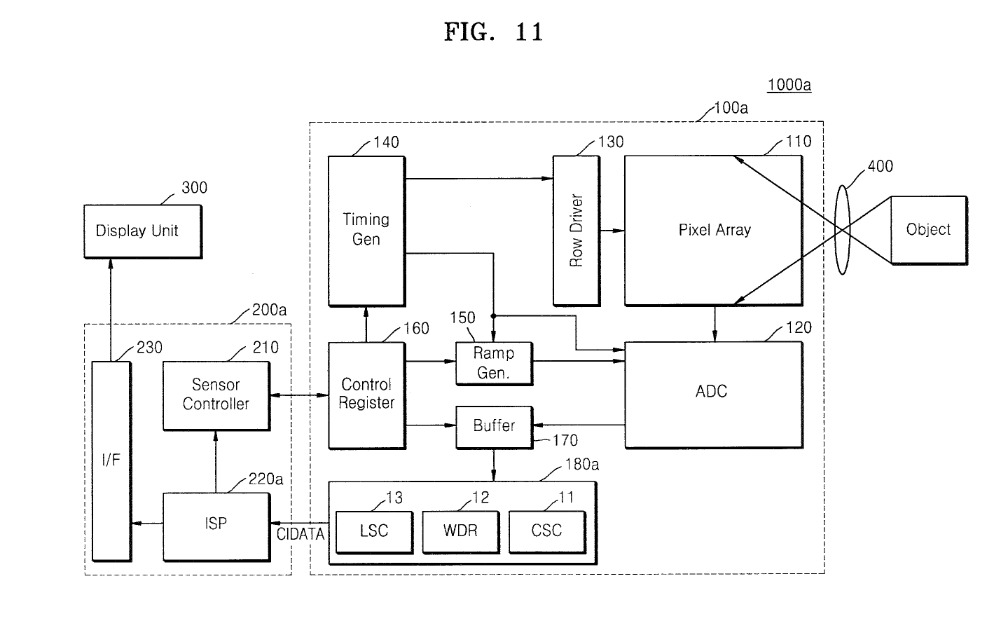

FIG. 9 is a flowchart of an example embodiment of a method of processing an image, in accordance with principles of inventive concepts. Raw image data may be obtained through the pixel array 14 of FIG. 1 and the ADC 15 in operation S110.

Color shading in the image data may be corrected in operation S120 where a color shading correction unit 11 such as previously described in the discussion related to image processing apparatuses 10, 10a and 10b applies different correction gains to different color channels of the image data and thereby corrects a color difference between the color channels. Correction gain functions having different coefficients may be applied and may be preset based on a white image, for example. The correction gains may be respectively calculated by the correction gain functions, which are determined according to locations of the pixel data, for each color channel. Alternately, the correction gains may be gain functions in which the color channels and the locations of the pixel data are parameters.

In operation S130 wide dynamic range correction is performed on image data that has been color-shading corrected in operation S130. In example embodiments, image reconstruction unit 12 combines values of the pixel data obtained by the pixels having different exposure times and then corrects the pixel data. As previously described, image reconstruction unit 12 may generate a wide dynamic range image by combining the pixel data of the pixels having different exposure times. In embodiments in which pixels have the long exposure times, for example, the pixel data of those pixels may be corrected by normalizing values of the neighboring pixels having short exposure times and interpolating the normalized values and values of the long exposure pixels. Inventive concepts are not limited thereto, however, and various image correction algorithms may be used in order to make the pixel data of the neighboring pixels smoothly connect and prevent the ghost artifact and definition degradation. Accordingly, the image data is reconstructed and a dynamic range of the image data is expanded and the bit depth of the pixel data may be increased.

In operation S140, lens shading is corrected for image data that has undergone wide dynamic range correction, and the resultant image data may be output as corrected image data. As previously described, lens shading correction may reduce brightness difference according to the locations of the pixel data by applying a preset correction gain for each location of pixel data to the pixel data of the image data. The correction gain may be preset as a gain function in which the locations of the pixels are the parameters and may be set based on a white image response, for example.

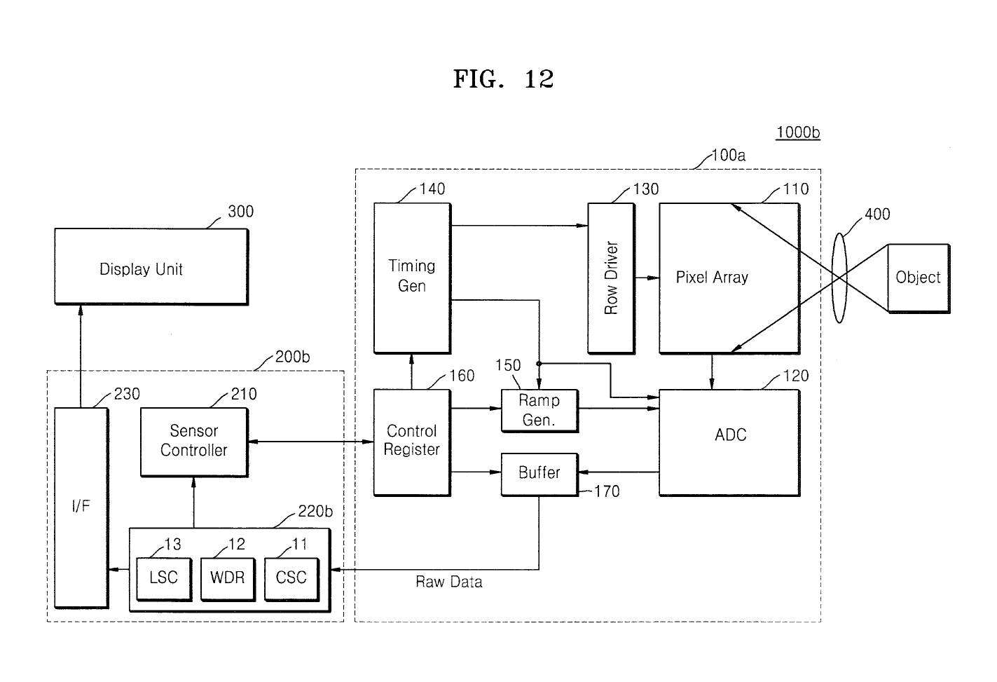

FIG. 10 is a flowchart of an example method of processing an image in accordance with principles of inventive concepts. Raw data is obtained in operation S210, and noise in the raw data is removed in operation 5220. In example embodiments in accordance with principles of inventive concepts, noise in a fixed pattern, reflected in the raw data, may be reduced or removed. In operation 5230 color shading of noise-reduced data is performed, and bad pixels of the image data are processed in operation 5240. In example embodiments in accordance with principles of inventive concepts, data corresponding to bad (that is, defective) pixels of a pixel array may be replaced by other pixel data. For example, the pixel data corresponding to bad pixels may be replaced by interpolation values of pixel data of adjacent pixels of the same color channel as the bad pixels. In step S250 wide dynamic ranged correction is performed and lens shading correction is performed in operation S260.

As described above, image processing operations such noise removal and defective pixel processing may be performed between obtaining raw data in operation S210 and performing wide dynamic range correction in operation S250. Additionally, when wide dynamic range correction is performed in operation S250, the bit depth of the pixel data that is expanded through the wide dynamic range correction may be converted. In accordance with principles of inventive concepts, various algorithms may be used to minimize any decrease in the dynamic range of the expanded image data.

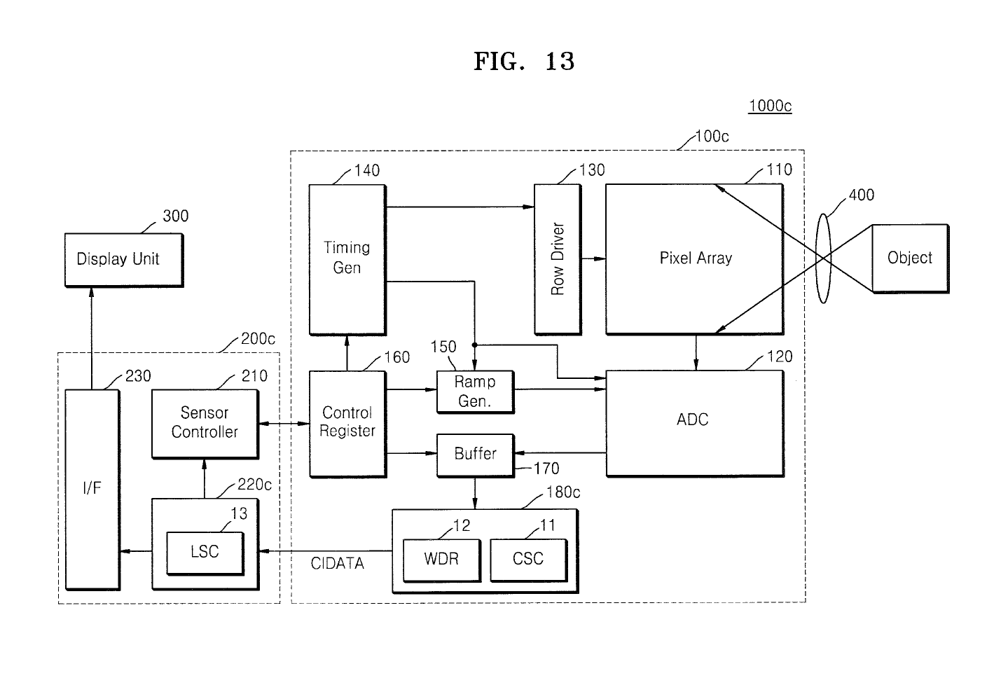

FIG. 11 is a block diagram of an example embodiment of a photographing apparatus 1000a in accordance with principles of inventive concepts. The photographing apparatus 1000a of FIG. 11 may be implemented as, or as an element of a portable device, for example, a digital camera, a mobile phone, a smartphone, or a tablet or personal computer (PC).

Photographing apparatus 1000a includes an image sensor 100a, an image processor 200a, and a display unit 300.

The image sensor 100a receives optical signals for an image of an object that is photographed or captured by an optical lens 400 and converts the optical signals into electrical signals and output the electrical signals. The image sensor 100a may correct the electrical signals and output corrected image data (CIDATA). The image sensor 100a may be implemented as a CMOS image sensor, for example.

The image sensor 100a includes a pixel array 110, a row driver 130, a timing generator 140, an ADC 120, a control register block 160, a ramp signal generator 150, a buffer 170, and a logic circuit 180a.

The pixel array 110 includes pixels (not shown) arranged in a matrix form and converts optical image signals into electrical pixel signals using each of the pixels.

The pixel array 110 may be implemented in an RGB pixel format. That is, each pixel may be implemented as a red pixel for converting light in a red spectrum into electrical signals, a green pixel for converting light in a green spectrum into electrical signals, or a blue pixel for converting light in a blue spectrum into electrical signals.

As another example, the pixel array 110 may be implemented in a cyan-magenta-yellow (CMY) pixel format. That is, each pixel may be implemented as a cyan pixel, a magenta pixel, or a yellow pixel.

The pixel array 110 may include pixel groups having different exposure times. According to example embodiments, each pixel may be implemented as a photodiode or a PIN photodiode.

The row driver 130 provides control signals, which respectively control operations of the pixels, to the pixel array 110 according to control of the timing generator 140.

The row driver 130 drives the pixel array 110 according to a row unit. For example, the row driver 130 may generate row selection signals. That is, the row driver 130 decodes row control signals generated by the timing generator 140 (for example, address signals, etc.) and may select at least one row from among rows forming the pixel array 110 in response to the decoded row selection signals. The pixel array 110 outputs pixel signals, which are transmitted by the at least one row selected by the row selection signals provided by the row driver 130, to the ADC 120. The pixel signals include reset signals and image signals.

The ADC 120 generates result signals by comparing the pixel signals with ramp signals provided by the ramp signal generator 150 and counts the result signals to convert them into digital signals. Then, the ADC 120 outputs the digital signals to the buffer 170 as raw data. For example, the ADC 120 may be implemented as a column-parallel single-slope ADC.

The timing generator 140 controls operations of the row driver 130, the ADC 120, and the ramp signal generator 150 according to the control of the control register block 160.

The control register block 160 may control operations of the timing generator 140, the ramp signal generator 150, and the buffer 170, respectively. The control register block 160 operates according to the control of a sensor controller 210. The sensor controller 210 may be implemented as a hardware component or a software component.

The buffer 170 outputs a plurality of the raw data output by the ADC block 120 to the logic circuit 180a.

The logic circuit 180a includes a color shading correction unit 11, an image reconstruction unit 12, and a lens shading correction unit 13. The logic circuit 180a may be any one of the image processing apparatuses 10, 10a and 10b according to one or more embodiments of the inventive concept.

In example embodiments logic circuit 180a sequentially performs color shading correction, wide dynamic range correction, and lens shading correction. CIDATA is output by the image processor 200a.

The image processor 210a may include an image signal processor 220a, the sensor controller 210, and an interface 230.

In example embodiments sensor controller 210 controls the control register block 160. The sensor controller 210 may use an Inter-Integrated Circuit (I²C) interface to control the image sensor 100a, that is, the control register block 160. However, inventive concepts are not limited thereto, and the sensor controller 210 may use various interfaces.

The image signal processor 220a controls the sensor controller 210 for controlling the control register block 160 and the interface 230. According to example embodiments, the image sensor 100a and an image signal processor 220a may be implemented as one package or a multi-chip package.

The image signal processor 220a processes the CIDATA received by the image sensor 100a and transmits the processed CIDATA to the interface 230.

The interface 230 transmits the CIDATA processed by the image signal processor 220a to the display unit 300.

The display unit 300 displays the CIDATA transmitted by the interface 230. The display unit 300 may be implemented as a thin film transistor-liquid crystal display (TFT-LCD), a light-emitting diode (LED) display, an organic LED (OLED) display, or an active-matrix OLED display, for example.

The display unit 300 may be any device capable of outputting an image. For example, the display unit 300 may include a computer, a mobile phone, and other image output terminals.

FIG. 12 is a diagram of an example embodiment of a photographing apparatus 1000b in accordance with principles of inventive concepts. Photographing apparatus 100b includes an image sensor 100b, an image processor 200b, and a display unit 300. The structure and operations of the photographing apparatus 1000b of FIG. 12 are similar to those of the photographing apparatus 1000a of FIG. 11 and detailed descriptions of items previously described will not be repeated here.

The image sensor 100b receives optical signals reflected from an external object through a lens 400 according to control of the image processor 200b and may generate raw data by converting the received optical signals into electrical signals. The image processor 200b processes the raw data and may transmit the processed raw data to the display unit 300 through the interface 230.

The image signals processor 220b includes a color shading correction unit 11, an image reconstruction unit 12, and a lens shading correction unit 13. The image signals processor 220b may include any one of the image processing apparatuses 10, 10a and 10b according to one or more embodiments of the inventive concept, for example. Color shading correction, wide dynamic range correction, and lens shading correction may be sequentially performed on the raw data transmitted by the image sensor 100b.

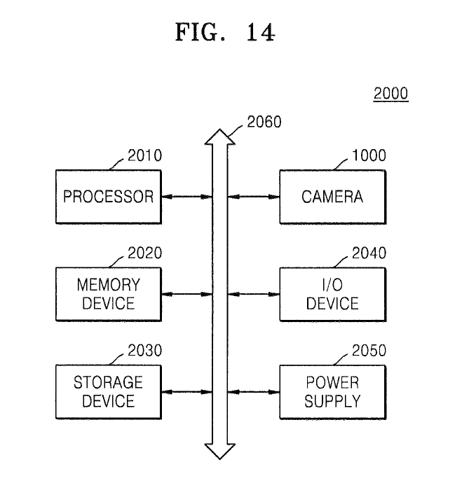

FIG. 13 is a diagram of an example embodiment of a photographing apparatus 1000c in accordance with principles of inventive concepts. Photographing apparatus 1000c includes an image sensor 100c, an image processor 200c, and a display unit 300. The structure and operations of photographing apparatus 1000c of FIG. 13 are similar to those of the photographing apparatus 1000a of FIG. 11 and, as a result, detailed description of elements will not be repeated here.

In FIG. 13, a logic circuit 180c included in the image sensor 100c includes a color shading correction unit 11 and an image reconstruction unit 12. The logic circuit 180c receives image data output by the buffer 170, for example, the raw data, and generates CIDATA by sequentially performing color shading correction and wide dynamic range correction to the image data. The image sensor 100c transmits the CIDATA to the image processor 200c.

An image signal processor 220c of the image processor 200c includes a lens shading compensation unit 13. The image signal processor 220c performs lens shading compensation on the CIDATA transmitted by the image sensor 100c and performs another process to the CIDATA. The processed image is output to the display unit 300 through the interface 230.

FIG. 14 is a block diagram of an example embodiment of a computing system 2000 including a photographing apparatus in accordance with principles of inventive concepts, such as 1000, 1000a, and 1000b of FIGS. 11 through 13.

Referring to FIG. 14, the computing system 2000 includes a processor 2010, a memory device 2020, a storage device 2300, an input/output (I/O) device 2040, a power supply 2050, and a camera 1000. Although not illustrated in FIG. 14, the computing system 2000 communicates a video card, a sound card, a memory card, a universal serial bus (USB), etc. or may further include ports capable of communicating with other electronic devices.

The processor 2010 may perform specific calculations or tasks. According to embodiments, the processor 2010 may be a micro-processor or a central processing unit (CPU). The processor 2010 may communicate with the memory device 2020, the storage device 2030, and the I/O device 2040 through a bus 2060 such as an address bus, a control bus, and a data bus. According to embodiments, the processor 2010 may be connected to an expansion bus such as a peripheral component interconnect (PCI) bus.

The memory device 2020 may store data necessary to operate the computing system 2000. For example, the memory device 2020 may be implemented as dynamic random access memory (DRAM), mobile DRAM, static RAM (SRAM), phase-change RAM (PRAM), ferroelectric RAM (FRAM), resistive RAM (RRAM), and/or magnetic RAM (MRAM). The storage device 2030 may include a solid state drive, a hard disk drive, or a CD-ROM.

The I/O device 2040 may include input devices such as a keyboard, a mouse, etc., and output devices such as a printer, a display, etc. The power supply 2050 may supply an operation voltage necessary to operate the computing system 2000.

In example embodiments camera 1000 is connected to and may communicate with the processor 2010 through the bus 2060 or other communication links. As described above, the camera 1000 sequentially performs color shading correction, wide dynamic range correction, and lens shading correction on the image data generated by the pixel array 110, for example, the raw data.

The camera 1000 may be implemented as various types of packages. For example, at least some components of the camera 1000 may be mounted by using packages such as a package on package (POP), ball grid arrays (BGAS), a chip scale packages (CSPS), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flatpack (TQFP), a small outline integrated circuit (SOIC), a shrink small outline package (SSOP), a thin small outline package (TSOP), a thin quad flatpack (TQFP), a system in package (SIP), a multi-chip package (MCP), a wafer-level fabricated package (WFP), a wafer-level processed stack package (WSP), etc.

For example, the computing system 2000 may include a digital camera, a mobile phone, a personal digital assistant (PDA), a portable multimedia player (PDP), a smartphone, etc.

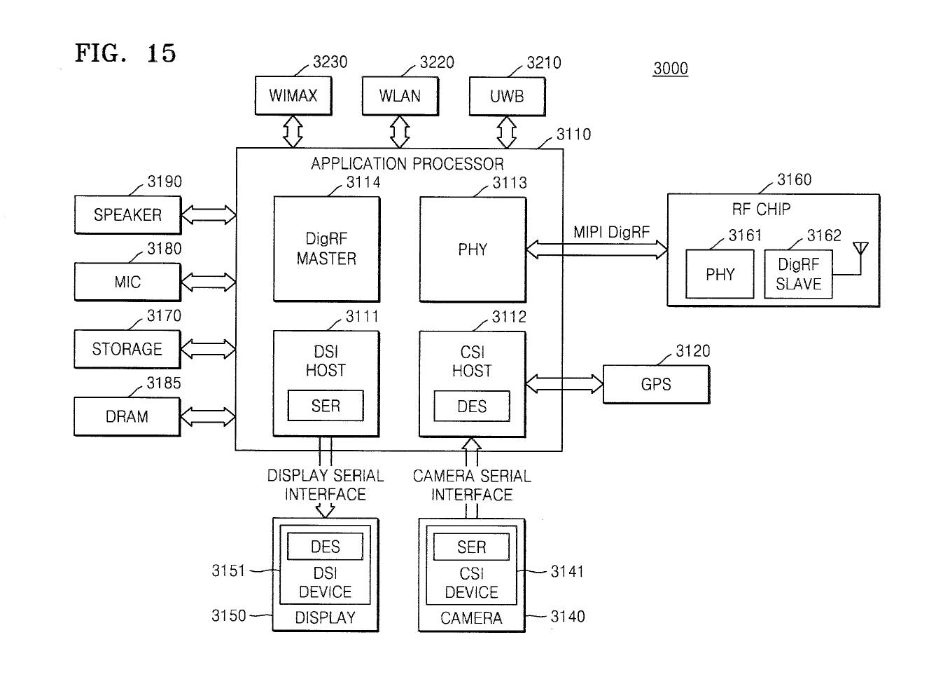

FIG. 15 is a block diagram of an electronic system in accordance with principles of inventive concepts. Electronic system 3000 may be implemented as a data processing device capable of using or supporting a mobile industry processor (MIPI) Interface and may include an application processor 3110, a camera 3140, and a display unit 3150. A camera serial interface (CSI) host 3112 of the application processor 3110 may serially communicate with the camera 3140 and a CSI device 3141 through a CSI.

The CSI host 3112 may include a deserializer (DES), and the CSI device 3141 may include a serializer (SER). A display serial interface (DSI) 3111 of the application processor 3110 may serially communicate with a display serial interface (DSI) device 3151 of the display unit 3150 through a DSI.

The DSI host 3111 may include an SER, and the DSI device 3151 may include a DES. Furthermore, the electronic system 3000 may further include a radio frequency (RF) chip 3160 capable of communicating with the application processor 3110. A physical layer (PHY) 3113 of the electronic system 3000 and a PHY 3161 of the RF chip 3160 may receive or transmit data according to a mobile industry processor interface (MIPI) DigRF. Also, the application processor 3110 may further include a DigRF master 3114 that controls the reception and transmission of data according to a MIPI DigRF.

The electronic system 3000 may include a global positioning system (GPS) 3120, a storage device 3170, a microphone 3180, DRAM 3185, and a speaker 3190. Also, the electronic system 3000 may communicate with an external device through ultra wideband (UWB) 3210, a wireless local area network (WLAN) 3220, a worldwide interoperability for microwave access (WIMAX) 3230, etc. However, a structure and an interface of the electronic system 3000 described herein are just an example and are not limited thereto.

While example embodiments of inventive concepts have been particularly shown and described, it will be understood that various changes in form and details may be made therein without departing from the spirit and scope of inventive concepts.

What is claimed is:

1. An image processing apparatus comprising:
a pixel array comprising a first pixel group having a first exposure time and a second pixel group having a second exposure time, and the pixel array configured to convert image signals into electrical signals;
an analog-digital converter (ADC) configured to convert the electrical signals into digital signals;
a color shading correction unit configured to correct a color difference of the digital signals and generate color-corrected digital signals;
an image reconstruction unit configured to reconstruct the color-corrected digital signals and generate reconstructed color-corrected digital signals; and
a lens shading correction unit configured to perform lens shading correction on the reconstructed color-corrected digital signals.

2. The image processing apparatus of claim 1, wherein the first exposure time and the second exposure are different from each other.

3. The image processing apparatus of claim 1, wherein the color shading correction unit is configured to apply different correction gains to different color channels of the digital signals.

4. The image processing apparatus of claim 2, wherein the image reconstruction unit is configured to combine a first pixel data and a second pixel data of the color-corrected digital signals, wherein the first pixel data and the second pixel data are obtained from the first pixel group and the second pixel group respectively.

5. The image processing apparatus of claim 4, wherein the image reconstruction unit is configured to expand a bit depth of the first pixel data and the second pixel.

6. The image processing apparatus of claim 5, further comprising a bit depth conversion unit configured to reduce the expanded bit depth of the first pixel data and the second pixel data.

7. The image processing apparatus of claim 1, wherein a value of a correction gain applied in the color shading correction unit is smaller than a value of a correction gain applied in the lens shading correction unit.

8. The image processing apparatus of claim 1, further comprising:
a noise removal unit configured to remove noise from the digital signals; and
a bad pixel processing unit configured to correct data generated from defective pixels of the pixel array.

9. An image processing apparatus comprising:
a pixel array comprising a first pixel group having a first exposure time and a second pixel group having a second exposure time, and the pixel array configured to convert image signals into electrical signals;
an analog-digital converter (ADC) configured to convert the electrical signals into digital signals; and
an image correction unit configured to correct a color difference of, reconstruct, and correct lens shading of the digital signals;
wherein reconstructing the digital signals is performed after correcting the color difference of the digital signals; and
wherein correcting lens shading of the digital signals performed after reconstructing the digital signals.

10. The image processing apparatus of claim 9, wherein the first exposure time and the second exposure are different each other.

11. The image processing apparatus of claim 9, wherein correcting the color differences of the digital signal is performed by applying different correction gains to different color channels of the digital signals.

12. The image processing apparatus of claim 10, wherein reconstructing the digital signals is performed by combining a first pixel data and a second pixel data of the digital signals, wherein the first pixel data and the second pixel data are obtained from the first pixel group and the second pixel group respectively.

13. The image processing apparatus of claim 12, further comprising a bit depth conversion unit configured to reduce the expanded bit depth of the first pixel data and the second pixel data.

14. A method of processing an image, comprising:
obtaining image data;
correcting a color difference of the image data;
increasing a dynamic range of the color-corrected image data; and
correcting lens shading of the color-corrected dynamic-ranged increased data.

15. The method of claim 14, wherein the obtaining of the image data comprises obtaining the image data from pixels of an image sensor which have different exposure times.

16. The method of claim 14, wherein the correcting of the color difference comprises applying a value of a correction gain, which is smaller than a value of a correction gain applied in correcting the lens shading, to the pixel data of the image data.

17. The method of claim 14, further comprising:
removing noise from the image data; and
correcting data from defective pixels from among pixels of the image data.

18. The method of claim 14, further comprising converting a bit depth of the image data of which a dynamic range is increased.
